(19) United States
(12) Patent Application Publication
(10) Pub. No.: US 2009/0209286 A1
(43) Pub. Date: Aug. 20, 2009

(54) AGGREGATED VIEW OF LOCAL AND REMOTE SOCIAL INFORMATION

(75) Inventors: Frank R. Bentley, Palatine, IL (US); Rafiq Ahmed, Hinsdale, IL (US); Joellen C. Kames, Chicago, IL (US); Lauren E. Schwendimann, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/033,268

(22) Filed: Feb. 19, 2008

(51) Int. Cl. H04M 1/00; G06F 17/30

(52) U.S. Cl. 455/556.1; 707/10; 707/E17.01

(57) ABSTRACT

Disclosed are a system and method for gathering social information that is of interest to a user of a communications device. Information is gathered both from the device itself (e.g., call logs) and remotely (e.g., from social-networking web sites). The gathered information is then intelligently aggregated and presented to the user in a unified format. In many cases, each piece of social information is associated with at least one virtual identity. Some embodiments rationalize the display of social information by using a contact-identity database that associates a contact person with his multiple virtual identities. In some embodiments, the user can specify how the information is to be displayed and can specify ways to filter the information. For example, the user can specify which contact people are of interest and can filter their social information based on the type of the information and the time at which the information was posted.

### FIELD OF THE INVENTION

The present invention is related generally to mobile communications devices, and, more particularly, to the user interface on such a device.

### BACKGROUND OF THE INVENTION

Millions of people currently use online social applications such as flickr, facebook, last.fm, and MySpace. They generate and post social information (such as photos that serve as visual presence updates or status messages about going to particular places) that is useful and sometimes captivating to members in their networks.

People also generate social information whenever they use their ever popular mobile telecommunications devices. This information includes recent and missed calls, SMS/MMS (Short Message Service/Multimedia Messaging Service) message history, e-mail history, captured media, and, increasingly, presence information (e.g., location, availability, and other current status information) coming into the device through protocols like XMPP (Extensible Messaging and Presence Protocol) and SIMPLE (Session Initiation Protocol for Instant Messaging and Presence Leveraging Extensions).

Due to its ubiquity and its multiple sources, social information is stored in myriad places, in myriad different formats, and is accessible via myriad applications, each application often able to access only one or a few types of social information. For example, if a user wants to view flickr updates from a friend, he goes to a web browser. To see missed calls, he runs a Recent Calls application. Messages are viewed in a messaging application.

Another aspect of the ever increasing use of social information is the proliferation of “virtual identities.” One person can at least one “identity” at each place where social information is generated. For example, this person may have multiple telephone numbers, several e-mail addresses, and various pseudonyms and monikers each usable only in a specific application.

### BRIEF SUMMARY OF THE INVENTION

The above considerations, and others, are addressed by the present invention, which can be understood by referring to the specification, drawings, and claims. According to aspects of the present invention, an application running on a communications device, such as a cell phone or personal digital assistant, gathers social information that is of interest to the device's user. Information is gathered both from the device itself (e.g., call logs) and remotely (e.g., from social-networking web sites). The gathered social information is then intelligently aggregated and presented to the device's user in a unified format.

In many cases, each piece of social information is associated with at least one virtual identity. Some embodiments rationalize the display of social information by using a contact-identity database that associates a contact person with his multiple virtual identities.

In some embodiments, the device's user can specify how the social information is to be displayed and can specify ways to filter the information. For example, the user can specify which contact people are of interest and can filter their social information based on the type of the information and the time at which the information was posted.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representative environment in which aspects of the present invention can be practiced;

FIG. 2 is a flowchart of an exemplary embodiment of aspects of the present invention;

FIG. 3 is a block diagram of a device made according to aspects of the present invention; and

FIGS. 4a, 4b, and 4c are representative screen shots from applications presenting aggregated local and remote social information to a user.

### DETAILED DESCRIPTION OF THE INVENTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

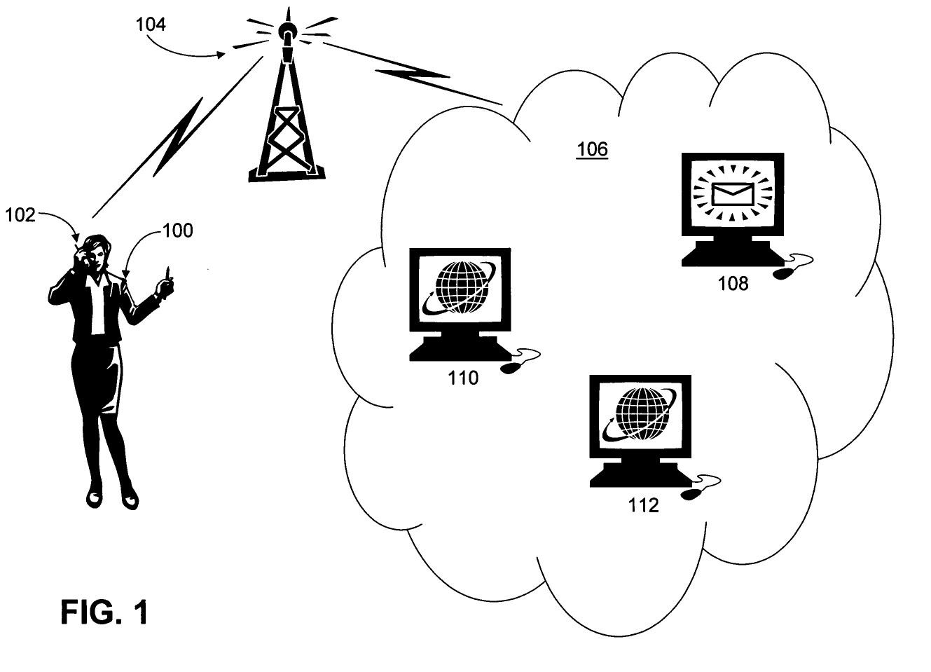

FIG. 1 presents an environment in which a person 100 can use an embodiment of the present invention. Simply by using a personal communications device 102, the user 100 generates social information that can be stored locally on the device 102. When the device 102 is a cellphone, for example, the locally stored social information includes a log of calls recently made to or from the device 102, a history of messages or e-mails, and a list of contact people. Many personal communications devices 102 are equipped with a media-capture device such as a camera. In that case, the locally stored social information can include photographs, videos, and sound clips captured by the device 102.

While FIG. 1 illustrates the personal communications device 102 as a cell phone, it could as easily be a personal digital assistant or a personal computer.

Many devices 102 are now able to receive “presence information” sent by their network access provider 104. This presence information can include social information such as location, availability, and status of a contact person. This social information can be stored locally on the personal communications device 102.

According to aspects of the present invention, the user 100 can access other social information beyond that which is normally stored in her personal communications device 102. For illustration's sake, FIG. 1 shows the Internet 106 and, on the Internet 106, providers 108, 110, and 112 of social and other information. These Internet-based providers 108, 110, and 112 can include social-networking sites, personal web sites of contacts known to the user 100, and a contact-identity server. The last device, like the contacts database stored locally on the communications device 102, is able to associate pieces of social information with contact people. For example, when a photograph is posted on the web, the contact-identity server might be able to associate a pseudonym attached to the photograph with the actual name of the posting person. The personal communications device 102 may also be able to make an association between social information and contacts based on information retrieved from Internet-based sources. For example, multiple sites may list a contact's email address, and identities can be matched based on this common information across sites. In some cases, security and privacy concerns will limit the user's 100 access to such associations. A server may also act as an aggregator of Internet-based information from other sources (e.g., from providers 108 and 110) and provide a single source of aggregated Internet-based social information to the personal communications device 102.

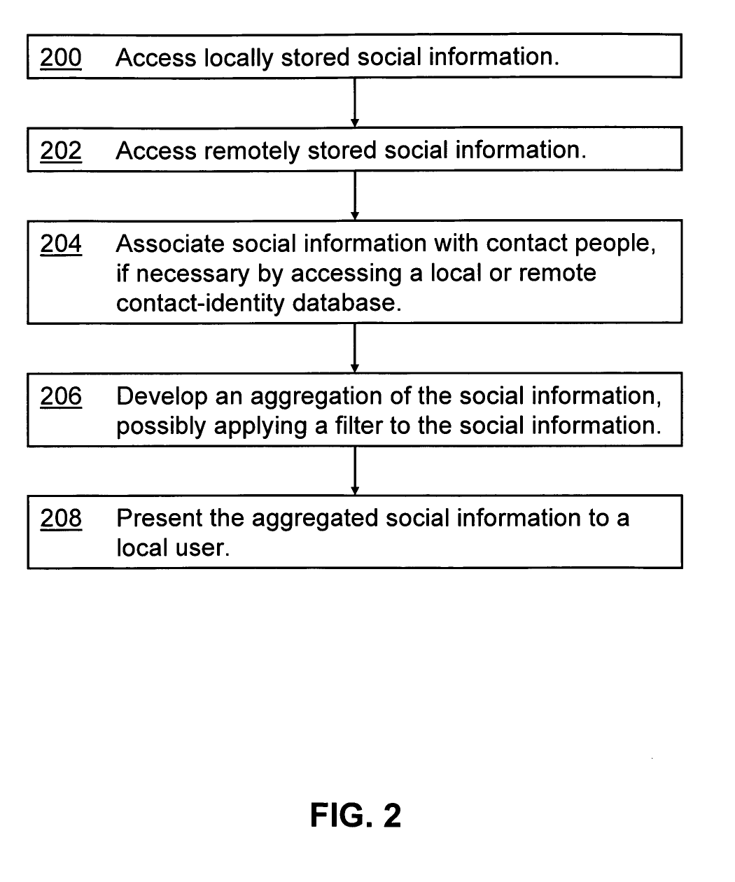

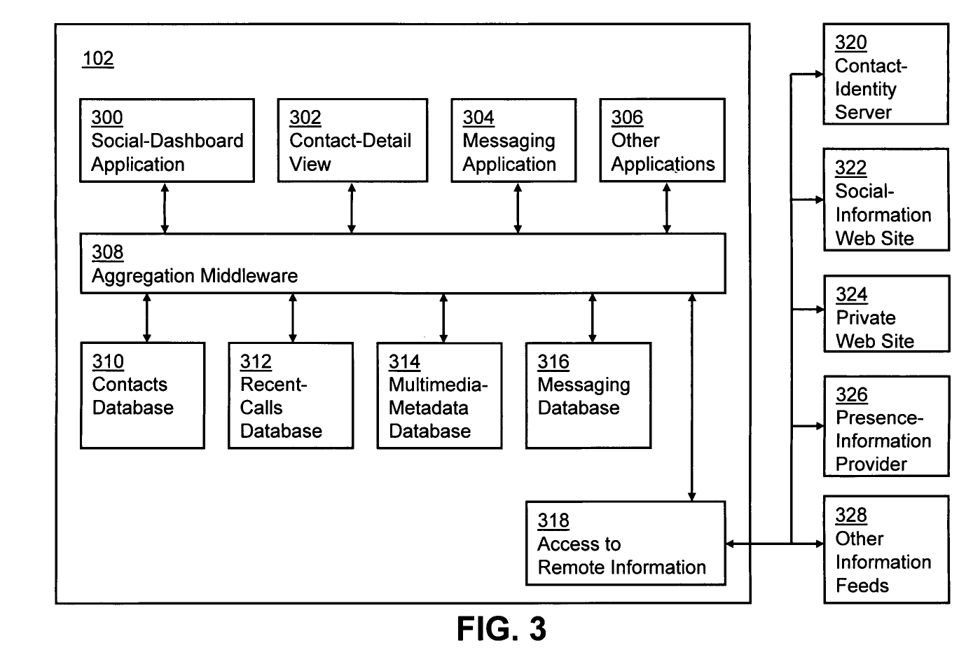

Because the amount of social information on the web is so large as to be potentially overwhelming to the user 100, aspects of the present invention intelligently aggregate different sorts of social information, screen out irrelevancies, and present the aggregated result to the user 100. This is discussed in greater detail below in reference to FIGS. 2 and 3, but an example can be given. The user 100 may be interested in social information related to her friend Sandy. Aspects of the present invention can search through locally stored social information for anything relating to Sandy, finding, perhaps, recent calls and messages to and from Sandy and presence information indicating that Sandy is currently unavailable by telephone. Remote providers 108, 110, and 112 are queried to discover that Sandy recently posted vacation photographs on a social web site. This information is aggregated into a coherent and comprehensive summary of Sandy's current social status. This summary is presented to the user 100 via one or more applications running on her personal communications device 102. In some embodiments, the user 100 navigates through the presentation on her device 102 to retrieve the complete social information that is summarized there.

FIG. 2 summarizes aspects of the methods of the present invention, and FIG. 3 presents a simplified block diagram of a personal communications device 102 that runs an embodiment of the present invention. In order to focus the discussion on aspects of the present invention, FIG. 3 does not display many well known pieces of a typical personal communications device 102 (e.g., a power supply, keyboard, and antenna). The physical and logical architecture of these types of device 102 is well known to those of skill in the relevant art.

As discussed above, stored locally on the personal communications device 102 are various types of social information. FIG. 3 illustrates this with a contacts database 310, a history of recent calls 312, a metadata database 314 for whatever multimedia resources are available on the device 102, and a messaging database 316. As illustrated in FIG. 3 (and as often implemented today), these local sources of social information are stored separately, each having its own data format, and each accessible only by its own particular application. Prior to the present invention, this social information could only be presented to the user 100 via these particular applications, leading to an incoherent and fragmented view. In embodiments of the present invention, on the other hand, the aggregation middleware 308 takes the first step in removing this fragmentation by itself accessing all of these local sources of social information (Step 200 of FIG. 2).

Taking a further step toward defragmenting the experience of the user 100, the aggregation middleware 308 uses the communications abilities 318 of the personal communications device 102 to access social information that is not stored locally (Step 202 of FIG. 2). This “remote” information (here, “remote” means anything not initially stored on the personal communications device 102) can include just about any type of social information that pertains to a person in whom the user 100 has shown interest. Social-information web sites 322 (e.g., trademarked sites flickr, facebook, last.fm, and MySpace) are a major source of this social information, but other possibilities, such as private web sites 324, providers of presence information 326, and data feeds 328 (e.g., Really Simple Syndication feeds) can also provide interesting information.

For the most part, this social information is only interesting if it can be associated with people of interest to the user 100. These associations are not always easy to make. Generally, each piece of social information is associated with an identity (e.g., the user name of the person who posted the information). However, one person may use a different “virtual identity” at each source of social information. For example, when the user 100 receives a telephone call from a friend, that friend's telephone number is one virtual identity. When the same friend sends an e-mail to the user 100, the friend's e-mail address is another virtual identity. The friend's set of virtual identities proliferates when he posts to social-information sites using pseudonyms or other monikers. To present an aggregated display of social information pertaining to this one friend, these different virtual identities should be mapped to the same person.

Step 204 of FIG. 2 performs this mapping. The identity associated with a piece of social information is fed into an information store that attempts to associate the identity with a contact person. Step 204 can access an information store local to the personal communications device 102. For example, the contacts database 310 associates a friend's name with a cellphone number. If necessary, Step 204 can also access a remote contact-identity server 320 that performs a similar kind of mapping.

In Step 206 of FIG. 2, the social information is aggregated in a way to make it easier for the user 100 to make sense of this information. There are a number of ways to do this; different methods are chosen depending upon what type of display will be made to the user 100 in Step 208. In any case, the user 100 can reduce the total amount of social information by filtering the information in some way. For example, the user 100 is probably only interested in social information associated with a specific set of people; other social information is ignored. The user 100 may also filter by the currency of the information. For example, some information may interest the user 100 only if it is very recent, such as location or presence information, while postings on social networking sites may be interesting even if they are somewhat older. Sometimes, the user 100 may filter by the type of information, for example, by filtering out all videos or posts to specific sites.

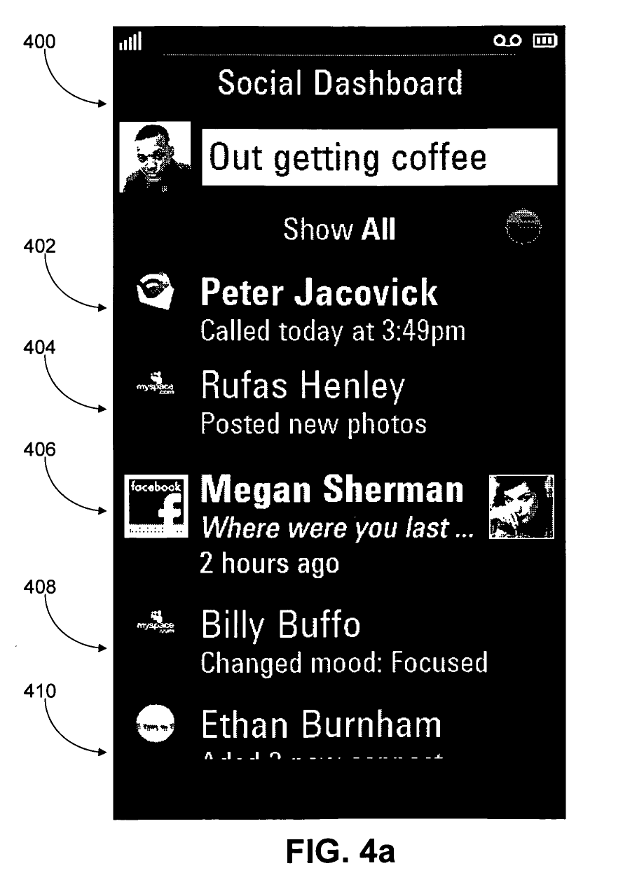

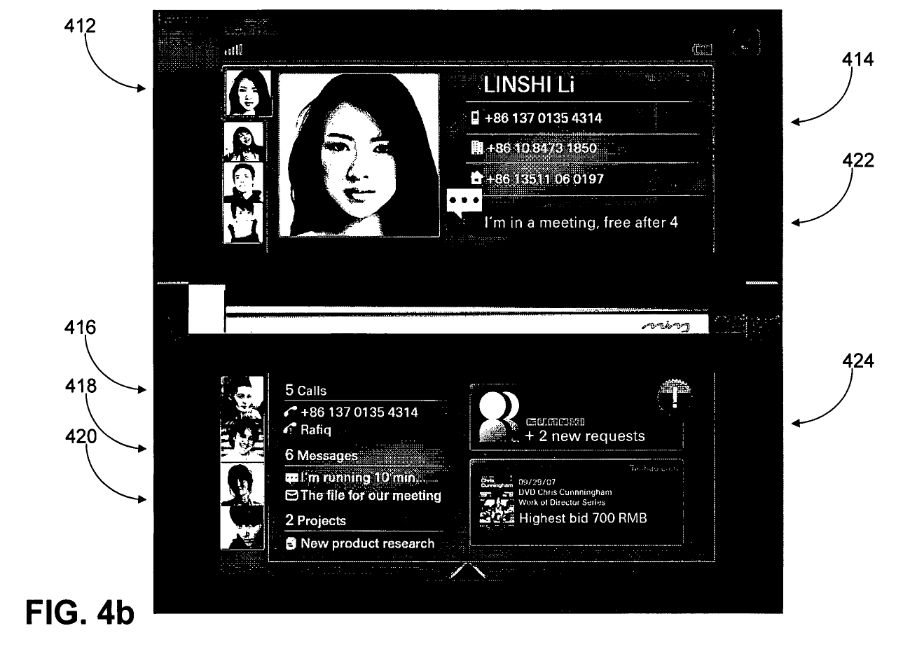

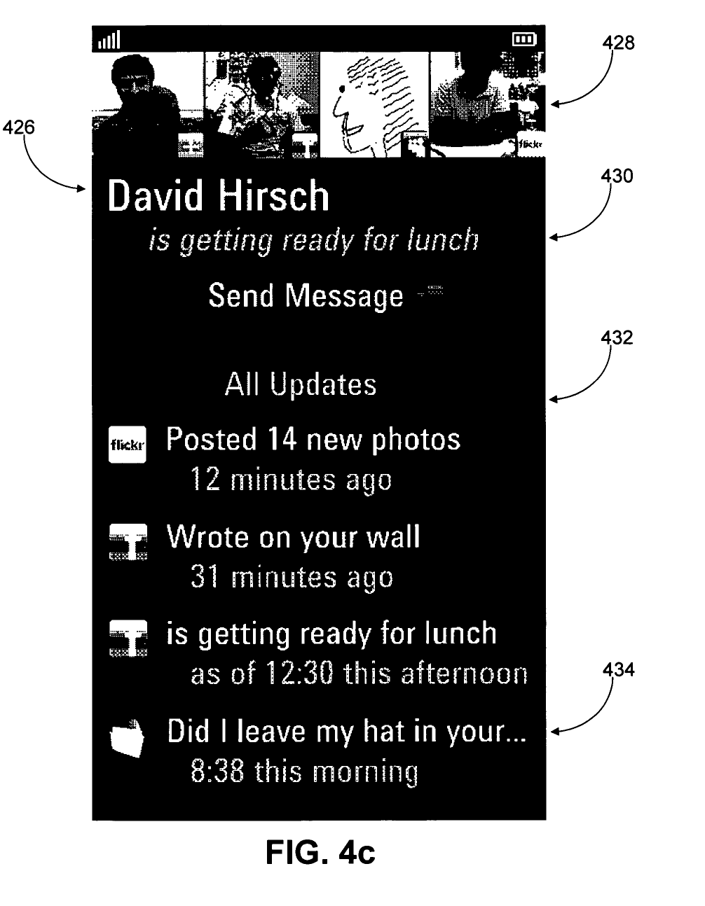

Step 208 of FIG. 2 presents the aggregated information, as filtered, to the user 100. Different user interfaces present different advantages in different situations, so FIG. 3 shows the aggregation middleware 308 supporting multiple presentation interfaces. A first example is the “Social Dashboard” 300, illustrated in FIG. 4a. This is an aggregate, time-based view 400 of social updates presented to the user 100 as an information feed. Updates can include local notifications from the personal communications device 102 (e.g., a missed call 402 and SMS and MMS messages 406) and remote social-network or social-media updates from friends (friend requests, a photo post 404, a status change from a friend 408, and a blog post 410). In the example of FIG. 4a, all updates are visible (“Show All”), but, as mentioned above, they could be filtered by, for example, contact person or update type.

A second example of a user interface is the “Contact Detail” application 302. This is illustrated in FIGS. 4b and 4c. Local (messages, calls) and remote (photos, status, updates) social information for one contact person is aggregated together into one screen. FIG. 4b is a Contact Detail screen 412 for Lin Shi that shows her contact information 414, her recent calls 416, messages 418, and files 420 (all local content) plus her social-network status message 422 and friend requests 424 (remote content).

The Contact Detail screen 426 of FIG. 4c has a different layout from the screen 412 of FIG. 4b. David Hirsch' Contact Detail screen 426 shows his social-network photos 428, his status message 430, and updates 432 as well as recent activity on his communications device 102 such as a text message 434.

In view of the many possible embodiments to which the principles of this invention may be applied, it should be recognized that the embodiments described herein with respect to the drawing figures are meant to be illustrative only and should not be taken as limiting the scope of the invention. For example, it is contemplated that new sources of social information will be introduced, and that embodiments of the present invention will be developed to aggregate their information along with information from presently known sources. Therefore, the invention as described herein contemplates all such embodiments as may come within the scope of the following claims and equivalents thereof.

We claim:

1. A method for presenting an aggregated view of social information to a user, the method comprising:
accessing local social information;
accessing remote social information;
associating at least some of the accessed local and remote social information with a contact person;
reviewing at least some of the accessed local and remote social information to develop an aggregation; and
based, at least in part, on the developed aggregation, presenting a social-information view to a user.

2. The method of claim 1 wherein accessing local social information comprises accessing at least one element selected from the group consisting of: a contacts database, a telephone call log, a message history, an e-mail history, a media-capture store, an instant-message conversation, location information, and presence information.

3. The method of claim 1 wherein accessing remote social information comprises accessing at least one element selected from the group consisting of: a web-based social information site, a contact-identity server, a private web page, an Internet-based social-information aggregation server, location information, presence information, status information, an information feed, and a personal profile.

4. The method of claim 1 wherein associating information with a contact person comprises reviewing a plurality of virtual identities to associate at least some of the virtual identities with the contact person.

5. The method of claim 1 wherein associating information with a contact person comprises accessing a remote contact-identity server.

6. The method of claim 1 wherein associating information with a contact person comprises accessing a local contacts database.

7. The method of claim 1 wherein developing an aggregation comprises applying a filter to the accessed social information.

8. The method of claim 7 wherein the filter applies a criterion selected from the group consisting of: date, associated contact person, location, status, information source, and information type.

9. A personal telecommunications device, the device comprising:
a telecommunications transmitter/receiver system;
a local social information store;
a program for accessing remote social information;
a program for developing an aggregation of local and remote social information; and
an interface for presenting to a user a social-information view, the social information view based, at least in part, on the developed aggregation.

10. The personal telecommunications device of claim 9 wherein the device is selected from the group consisting of: a cellular telephone, a personal digital assistant, and a personal computer.

11. The personal telecommunications device of claim 9 wherein the local social information comprises at least one element selected from the group consisting of: a contacts database, a telephone call log, a message history, an e-mail history, a media-capture store, an instant-message conversation, location information, and presence information.

12. The personal telecommunications device of claim 9 wherein accessing remote social information comprises accessing at least one element selected from the group consisting of: a web-based social information site, a contact-identity server, a private web page, an Internet-based social-information aggregation server, location information, presence information, status information, an information feed, and a personal profile.

13. The personal telecommunications device of claim 9 wherein developing an aggregation of local and remote social information comprises applying a filter to at least some social information.

14. The personal telecommunications device of claim 13 wherein the filter applies a criterion selected from the group consisting of: date, associated contact person, location, status, information source, and information type.

15. The personal telecommunications device of claim 9 further comprising:
a program for associating local and remote social information with a contact person.

16. The personal telecommunications device of claim 15 wherein associating social information with a contact person comprises reviewing a plurality of virtual identities to associate at least some of the virtual identities with the contact person.

17. The personal telecommunications device of claim 9 further comprising:
a program for accessing a remote contact-identity server.
